(19) United States
(12) Patent Application Publication
(10) Pub. No.: US 2003/0071530 A1
(43) Pub. Date: Apr. 17, 2003

(54) Permanent magnet type rotary eletric machine

(76) Inventor: Hideaki Takahashi, Shuuchi-gun (JP)

Correspondence Address: ERNEST A. BEUTLER, ATTORNEY AT LAW, 500 NEWPORT CENTER DRIVE, SUITE 945, NEWPORT BEACH, CA, 92660, US

(21) Appl. No.: 10/065,312

(22) Filed: Oct. 2, 2002

(30) Foreign Application Priority Data
Oct. 11, 2001 (JP) 2001-313783

(51) Int. Cl. H02K 21/12

(52) U.S. Cl. 310/156.48

(57) ABSTRACT

A number of embodiments of mechanisms for rotating electrical machines wherein the cogging torque of the machine can be effectively cancelled by generating a cancellation cogging torque. This can be done either mechanically or electrically and in some embodiments, the cancellation mechanism can be disabled under conditions when cogging presents no significant problem.

### BACKGROUND OF INVENTION

This invention relates to a rotary electric machine, such as a brushless DC motor or generator embodying permanent magnets rotor and more particularly to arrangements for eliminating or reducing undesirable characteristics of such machines.

It has been well known that the periodic variation in the output torque of a brushless DC motor using permanent magnets due to a condition referred to as “cogging torque”. This cogging torque is generated by the attractive or repulsive force between the permanent magnets and the magnetic poles or teeth on which the windings are formed. The period of this cogging torque is determined by the least common multiple of the number of permanent magnet poles and the number of slots formed between the teeth.

This cogging torque is particularly noticeable at a low speed or low output torque in, for example, an electric motor. For example, in an application such as an electric power assisted steering device using an electric motor for assisting steering force, when the steering angle and the steering force are small such as during a high speed running or the like, this cogging torque can cause an undesirable feel in the steering. This is just one example of a situation where the cogging torque results in reduced or undesirable performance.

It is therefore a principle object of this invention to provide a permanent magnet type rotary electric machine with reduced cogging torque for smooth rotation.

### SUMMARY OF INVENTION

A first feature of the invention is adapted to be embodied in a rotating electrical machine comprised of a primary device having a pair of relatively rotatable assemblies consisting of one assembly comprised of a plurality of circumferentially spaced permanent magnets of alternating polarity. The other of the assemblies is comprised of a plurality of radially extending, magnetic poles having ends cooperating with said permanent magnets and surrounded by coil windings and defining slots therebetween. Relative rotation of the assemblies of the primary device generates a cogging torque determined by the least common multiple of the number of said magnets and the number of said slots. A cogging torque canceling device is provided that generates a cogging torque out of phase with and substantially canceling that of said primary assembly.

In accordance with a further feature of the invention, the cogging torque canceling device is selectively operable.

### BRIEF DESCRIPTION OF DRAWINGS

FIG. 1 is a graphical showing the cogging torque and canceling cogging torque generated in accordance with the invention and the resulting torque.

FIG. 2 is a cross sectional view taken through a rotating electrical machine such as a brushless DC motor utilizing a first embodiment of the invention.

FIG. 3 is a cross sectional view taken along the line 3-3 of this embodiment.

FIG. 4 is a cross sectional view taken along the line 4-4 of this embodiment.

FIG. 5 is a cross sectional view, in part similar to FIG. 2, and shows a second embodiment of the invention.

FIG. 6 is a cross sectional view taken along the line 6-6 of FIG. 5.

FIG. 7 is a cross sectional view taken along the line 7-7 of FIG. 5.

FIG. 8 is a cross sectional view, in part similar to FIGS. 2 and 5, and shows a third embodiment of the invention.

FIG. 9 is a cross sectional view taken along the line 9-9 of FIG. 8.

FIG. 10 is a cross sectional view taken along the line 10-10 of FIG. 8.

FIG. 11 is a view of another type of device that may be employed for canceling the cogging torque in accordance with a fourth embodiment of the invention.

FIG. 12 is a cross sectional view taken along the line 12-12 of FIG. 11.

FIG. 13 is a developed view of the area encircled in FIG. 11 showing the relationship of the elements to explain how the cancellation force is generated.

### DETAILED DESCRIPTION

Summary of the Concept

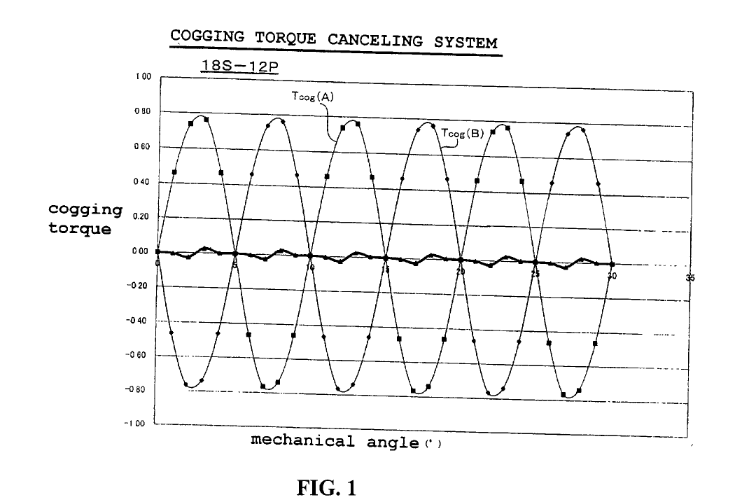

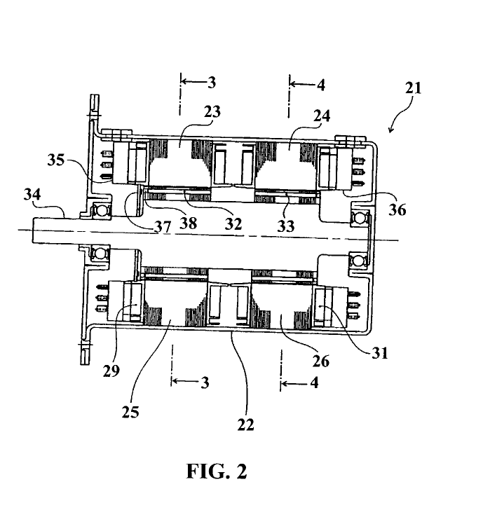

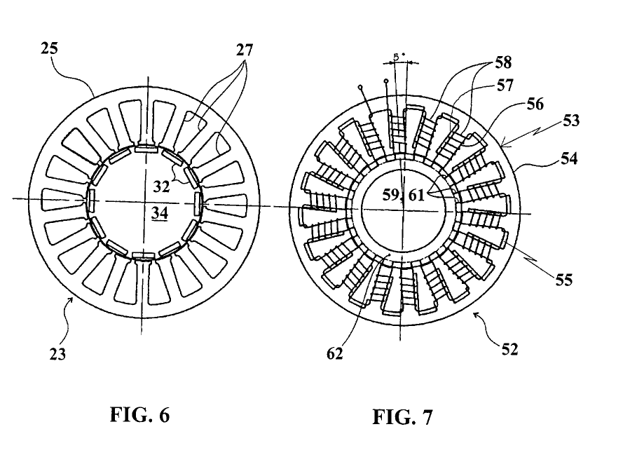

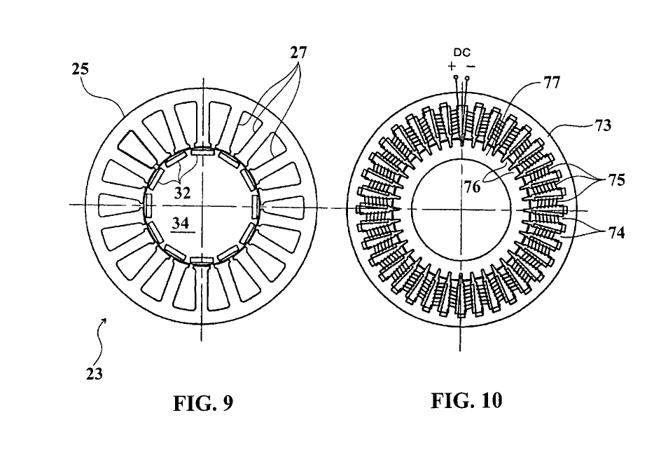

The principal of the invention which is embodied in the specific embodiments of FIGS. 2 through 4, 5 through 7, 8 through 10 and 11 and 12 will be described first by reference to FIG. 1. FIG. 1 illustrated an embodiment of rotating electrical machine having 18 gaps or spaces formed between magnetic pole teeth around which coils are wound and which cooperates with a plurality of circumferentially spaced permanent magnets of alternating polarity, in this case, their being 12 such magnetic poles.

The cogging torque for such a machine is represented as a sinusoidal curve that completes a complete cycle during a 360° “electrical angle”. That is a 360° “electrical angle” is defined as the angle of relative rotation during which a complete cycle of electrical power occurs. The actually mechanical angle of relative rotation during which this 360° electrical angle occurs is determined by dividing 360° by the “cogging number”.

The cogging number is the number of complete cycles that occur during a complete rotation of the machine. This cogging number is determined by the least common integral multiplier of the number of slots and the number of poles. In this case since there are 18 slots and 12 poles, the cogging number is 36.

Thus, there are 36 cycles occurring during a complete revolution of the machine or one cycle every 10° of mechanical angle rotation. This cogging torque curve is indicated by the curve A. In accordance with the invention, a cogging torque canceling device is employed which can take the form of the aforenoted embodiments of FIGS. 2 through 4, 5 through 7, 8 through 10 and 11 and 12.

In each of these embodiments, a sinusoidal canceling cogging torque is generated and is staggered relative to the main cogging torque so as to in effect cancel it out. Thus, with the example given the output of the cogging canceling mechanism is staggered by 5° relative to that of the main or primary mechanism comprising the coils, their magnetic pole cores and the permanent magnets.

As a result and as shown in the solid line curve, the sum of the torques cancel and provide a very smooth output. The way this is accomplished will now be described by reference to the various and specific embodiments.

Embodiments of FIGS. 2 through 5As afore described, it should be apparent that this invention may be utilized in either a rotating electric motor or a rotating electric generator, although the embodiments illustrated all comprise motors. In this first embodiment, the electric motor embodying the invention is identified generally by the reference numeral 21 and includes a housing 22 in which a first motor, a primary motor, indicated generally by the reference numeral 23, is positioned coaxially with the cogging torque canceling motor indicated generally by the reference numeral 24. This comprises a secondary motor in this embodiment.

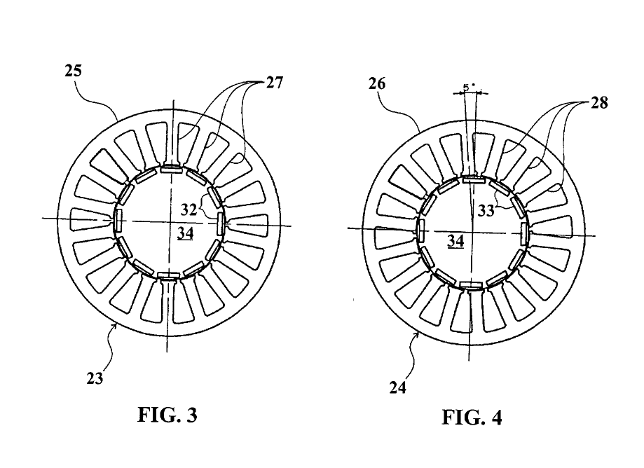

The motors 23 and 24 each include, in this embodiment, stators which are comprised of magnetic pole devices 25 and 26, respectively, each of which have respective individual pole teeth 27 and 28 (See FIGS. 3 and 4). Electrical coils 29 and 31 not shown in FIGS. 3 and 4 but illustrated in FIG. 2, are wound around these pole teeth.

In this embodiment, the physical characteristics of the two motors 23 and 24 are identical and thus, each have the same number of magnet pole teeth, defining eighteen (18) slots therebetween. In accordance with the invention and utilizing the previously described example, these coil windings 29 and 31 and magnetic pole teeth 27 and 28 cooperate with twelve (12) circumferentially spaced, alternating polarity, permanent magnets 32 and 33, respectively. The magnets 32 and 33 are disposed at the same spacing around the periphery of a motor output shaft 34 to which they are affixed in any suitable manner.

The pole teeth 28 of the motor 24 are, however, offset by 5° of mechanical angle relative to the pole teeth 27 of the motor 23 so as to provide the cogging torque curve as shown in FIG. 1.

Control circuits 35 and 36, respectively, are associated with the coils for controlling the electrical current to them under the control, for example, a Hall type sensor 37 that cooperates with a magnetic detector 38 formed at one end of the respective motors 23 and 24, as is well known in this art.

Thus, in connection with this embodiment, the electric motor includes a cogging canceling mechanism which not only reduces the cogging torque for the total machine but also permits the attainment of a greater power. Of course, the power is not as great as if the two motors were in complete phase, but the loss of power is more than offset by the reduction in cogging torque.

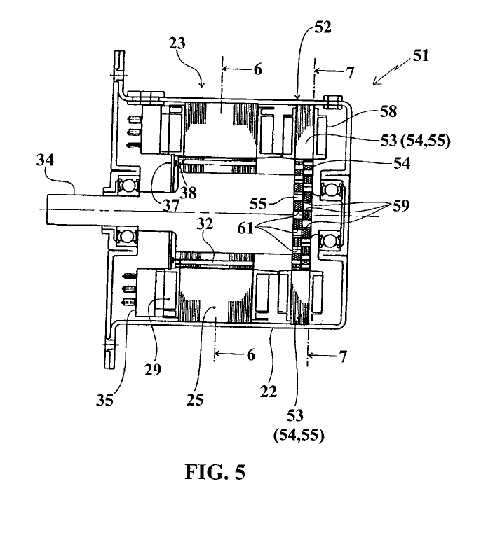

Embodiment of FIGS. 5-7

With the embodiment as thus far described, it is possible to reduce the cogging torque and improve the performance of the motor. However, in many applications, the cogging torque problem is only significant when operating at low speeds and low torques, as noted in the preamble hereto. Therefore, FIGS. 5 through 7 shows another embodiment which is operative at selected times to generate the cogging canceling action.

This embodiment is generally the same as the embodiment thus far described. However in this embodiment the motor, indicated generally by the reference numeral 51 utilizes a smaller cogging canceling mechanism, indicated generally by the reference numeral 52. The motor housing construction and the construction of the primary motor are the same as in the previously described embodiment and, therefore, these components have been indicated by the same reference numerals and will be described again only insofar as is necessary to understand the construction and operation of this embodiment.

In this embodiment, the cogging torque canceling mechanism is comprised of a stator core, indicated generally by the reference numeral 53 which comprises a pair of armature cores 54 and 55 each of which have respective pole teeth 56 and 57. In this embodiment, the number of pole teeth on each of the cores 54 and 55 is equal to 18 so that the total number of pole teeth is 36, the cogging number.

These pole teeth 56 and 57 are surrounded by windings 58. By utilizing a split core with a lesser number of pole teeth on each core and having them slightly staggered, it is possible to maintain larger gaps and still have the same number of effective pole teeth. This permits a much more compact mechanism and a greater degree of winding. The windings are such that they extend in opposite directions on adjacent pole teeth. In this embodiment, the shaft 34 is provided with a pair of rows of permanent magnets 59 and 61 equal in numbers to the pole teeth 56 and 57. This portion of the shaft 54 is indicated by the reference numeral 62.

In this embodiment, when the motor 23 is operated at low speeds and low loads, the windings 58 are energized so as to provide the cogging canceling torque as shown in FIG. 1. As the speed and low increase, the current flow can be decreased and subsequently cancelled at the desired engine speed when the cogging torque does not present any significant problem.

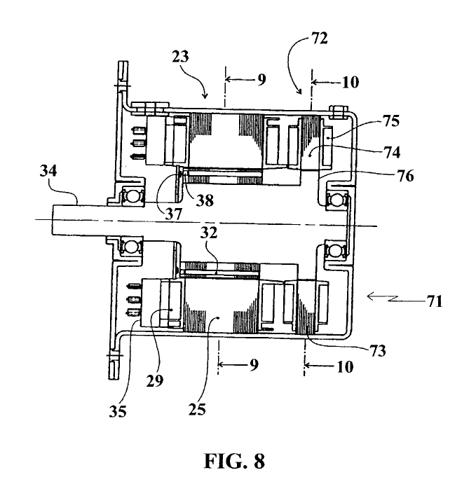

Embodiment of FIGS. 8-10

FIGS. 8 through 10 show a still further embodiment of electric motor having a cogging canceling mechanism in accordance with another embodiment of the invention and which can also be selectively energized. In this embodiment, the motor is indicated generally by the reference numeral 71 and has a primary motor as with the previously described embodiments which, therefore, is again identified by the same reference numeral 23. The sub-components of the main or primary motor 23 are the same as those already described and, for that reason, components which are the same or substantially the same have been identified by the same reference numerals and will not be described again except in so far as may be necessary to understand the construction and operation of this embodiment.

In this embodiment, the cogging canceling mechanism, indicated generally by the reference numeral 72 includes, as shown in FIG. 10, a stator core 73 having a plurality of pole teeth 74. In this embodiment, there are 36 circumferentially spaced pole teeth which are offset at a small angle such as 5° from the pole teeth 27 of the primary motor 23. These pole teeth are encircled by coil windings 75 which are wound in opposite directions.

The pole teeth 75 cooperate with alternating polarity permanent magnets 76 formed on an extension, the motor shaft 34, which extension is indicated by the reference numeral 77. With this embodiment, like the embodiment of FIGS. 5 through 7, the coil windings 75 need be engaged or energized only under lower speed and load ranges when cogging can become objectionable.

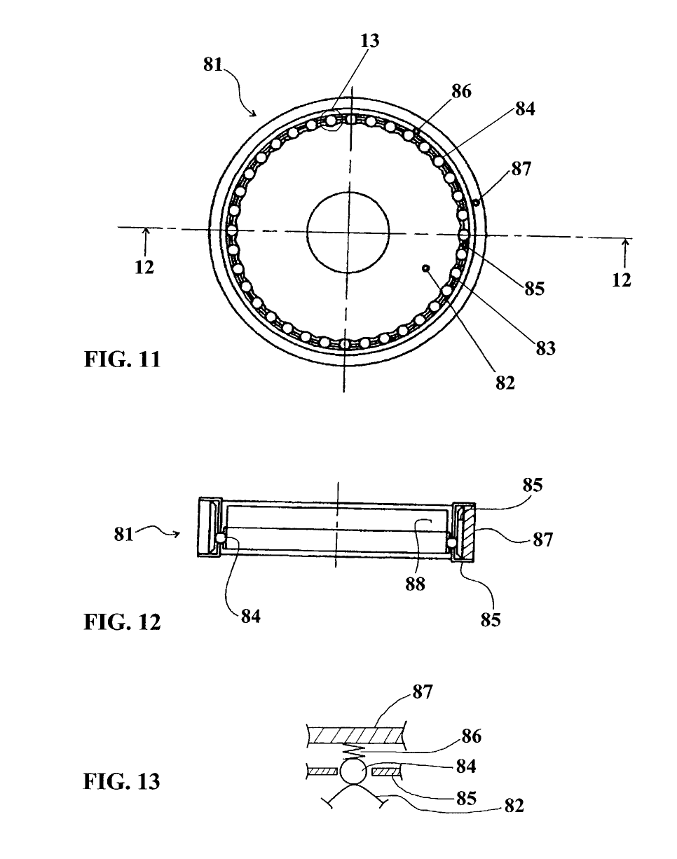

Embodiment of FIGS. 11-13

In all of the embodiments as thus far described, the cogging canceling force has been generated by another rotating electrical machine which operates to provide an electrical cogging torque that is out of phase with that of the main machine and which cancels it. Next will be described an embodiment, as shown in FIGS. 11 through 13, wherein the cogging canceling force is generated mechanically.

In this embodiment, the primary machine is the same as has been illustrated and described in the previous embodiments and therefore a further illustration of it is not believed to be necessary to permit those skilled in the art to practice the invention. In this embodiment, there is provided on the output shaft 34 a cam wheel, indicated by the reference numeral 81, that has a sinusoidal shaped outer surface 83 formed thereon which has a number of valleys and crests equal to the cogging number, 36 in the examples previously mentioned.

In engagement with this surface 83, are a plurality of balls 84 the circumferential position of which is held by a rotationally fixed, retainer ring 85. Coil compression springs 86 (are fixed to an outer ring 87 that is held against rotation to the outer housing of the machine. The springs 86 urge the balls 84 into engagement with the surface 83. Thus, as the shaft 34 rotates, the balls 84 will give a varying force that has a sinusoidal shape tending to resist rotation. This resistive force has the same shape as that of a cogging force. This force is designed so as to be out of phase with the cogging torque curve so as to cancel the forces and make the machine operation smoother.

As seen in FIG. 12, the ratchet wheel 82 has a portion 88 that is not formed with the sinusoidal shape surface but is a shape of a cylinder. By moving the ratchet wheel 82 axially along the shaft 34, which is possible by means of a splined connection therewith, the operation of the balls 84 and the force drag created thereby can be eliminated. Alternatively, the retainer 85, springs 86, outer ring 87 can be moved axially to position the balls 84 in registry with the cylindrical portion 88 to avoid this force generation. Thus, with this mechanical system it is also possible to provide the cogging cancellation only under low speeds and low torques on the primary motor.

Thus, from the foregoing description, it should be readily apparent that the described embodiments provide an extremely effective arrangement for canceling the cogging action of a rotating electrical machine. In addition, some of these embodiments permit selective operation of the cogging canceling mechanism. Of course, the foregoing description is that of preferred embodiments of the invention and various changes and modifications can be made without departing from the spirit and scope of the invention, as defined by the appended claims.

1. A rotating electrical machine comprised of a primary device having a pair of relatively rotatable assemblies consisting of one assembly comprised of a plurality of circumferentially spaced permanent magnets of alternating polarity, the other of said assemblies being comprised of a plurality of radially extending, magnetic poles having ends cooperating with said permanent magnets and surrounded by coil windings and defining slots therebetween, relative rotation of said assemblies generating a cogging torque determined by the least common multiple of the number of said magnets and the number of said slots, and a cogging torque canceling device for generating a canceling cogging torque out of phase with and substantially canceling that of said primary assembly, said cogging torque canceling device having a second pair of relatively rotatable assemblies.

2. A rotating electrical machine as set forth in claim 1, wherein the cogging torque canceling device is selectively operable for selectively generating its cogging torque.

3. A rotating electrical machine as set forth in claim 2, wherein the cogging torque canceling device is operable only at lower speeds of relative rotation of the primary device.

4. A rotating electrical machine as set forth in claim 1, wherein the cogging torque canceling device generated the canceling cogging torque electrically.

5. A rotating electrical machine as set forth in claim 4, wherein the second pair of relatively rotatable assemblies of the cogging torque canceling device is comprised of one assembly comprised of a plurality of circumferentially spaced permanent magnets of alternating polarity, the other of said assemblies of said cogging torque canceling device being comprised of a plurality of radially extending, magnetic pole teeth having ends cooperating with said permanent magnets and surrounded by coil windings and defining slots therebetween, relative rotation of said second pair of relatively rotatable assemblies generating a canceling cogging torque determined by the least common multiple of the number of said magnets and the number of said slots.

6. A rotating electrical machine as set forth in claim 5, wherein the first and second pair of relatively rotatable assemblies have substantially the same construction and are out of phase with each other.

7. A rotating electrical machine as set forth in claim 6, wherein the phase difference between the first and second pair of relatively rotatable assemblies is equal to one half of the mechanical rotational angle of a single phase of the cogging torque of the first relatively rotatable assembly.

8. A rotating electrical machine as set forth in claim 5, wherein the number of magnetic pole teeth of the second pair of relatively rotatable assemblies is equal to the coggings of the first pair of relatively rotatable assemblies during a single rotation thereof.

9. A rotating electrical machine as set forth in claim 8, wherein the magnetic pole teeth of the second pair of relatively rotatable assemblies are equally spaced.

10. A rotating electrical machine as set forth in claim 9, wherein the cogging torque canceling device is selectively operable for selectively generating its cogging torque.

11. A rotating electrical machine as set forth in claim 10, wherein the selective operation of the cogging torque canceling device is achieved by controlling current in the coil windings of the second pair of relatively rotatable assemblies.

12. A rotating electrical machine as set forth in claim 8, wherein the magnetic pole teeth of the second pair of relatively rotatable assemblies are formed by two sets of rings each having the same number of magnetic pole teeth as the first pair of relatively rotatable assemblies with the pole teeth thereof equally spaced and slightly offset from each other in a circumferential direction.

13. A rotating electrical machine as set forth in claim 12, wherein the cogging torque canceling device is selectively operable for selectively generating its cogging torque.

14. A rotating electrical machine as set forth in claim 13, wherein the selective operation of the cogging torque canceling device is achieved by controlling current in the coil windings of the second pair of relatively rotatable assemblies.

15. A rotating electrical machine as set forth in claim 1, wherein the cogging torque canceling device generates the canceling cogging torque mechanically.

16. A rotating electrical machine as set forth in claim 15, wherein the second pair of relatively rotatable assemblies comprises a cam mechanism for generating a sinusoidal force resisting relative rotation that is equal to the cogging torque of the first pair of relatively rotatable assemblies.

17. A rotating electrical machine as set forth in claim 16, wherein the cam mechanism comprises a rotating cam acting on a plurality of ball followers.

18. A rotating electrical machine as set forth in claim 17, wherein the cogging torque canceling device is selectively operable for selectively generating its cogging torque.

19. A rotating electrical machine as set forth in claim 18, wherein the selective operation of the cogging torque canceling device is achieved by moving the rotating cam acting and ball followers out of contact with each other.
